(19) United States
(12) Patent Application Publication
(10) Pub. No.: US 2013/0130678 A1
(43) Pub. Date: May 23, 2013

(54) METHOD, SYSTEM, APPARATUS AND RELATED COMPUTER PROGRAMS FOR SELECTING A WIRELESS NETWORK

(71) Applicant: Paolo Zanier, Munich (DE)

(72) Inventor: Paolo Zanier, Munich (DE)

(73) Assignee: NOKIA SIEMENS NETWORKS OY, ESPOO (FI)

(21) Appl. No.: 13/811,511

(22) PCT Filed: Jul. 23, 2010
(86) PCT No.: PCT/EP2010/060737

§ 371 Date: Jan. 22, 2013

(51) Int. Cl. H04W 8/06

(52) U.S. Cl. CPC H04W 8/065
USPC 455/433; 455/435.2; 455/435.3

(57) ABSTRACT

A method, a system, apparatuses and computer programs all select at least one wireless network via a mobile apparatus. The mobile apparatus may detect the available wireless networks and may send a first list containing information of at least a part of the available wireless networks to a network apparatus. The network apparatus may elect from the first list at least one wireless network and may transmit a second list, containing the at least one elected wireless network, back to the mobile apparatus. The mobile apparatus may then perform the network selection taking the received second list into account.

### TECHNICAL FIELD OF THE INVENTION

The present invention relates generally to wireless network selection at a mobile apparatus. More specifically, the present invention relates to a method, a system, apparatuses and related computer programs for performing a selection of a wireless network.

Embodiments of the present invention are applicable, but not limited, to Global System for Mobile communication (GSM) networks, Universal Mobile Telecommunications System (UMTS) networks, Code Division Multiple Access (CDMA) networks, Worldwide Interoperability for Microwave Access (WIMAX) networks, Wireless Local Area Networks (WLAN), Long Term Evolution (LTE) and System Architecture Evolution (SAE) networks.

### BACKGROUND OF THE INVENTION

The number of available wireless networks is steadily increasing. Mobile apparatuses may comprise growing support to connect to different wireless networks even if they are from different technologies (for example GSM, UMTS and Wimax).

If the mobile apparatus is in the reach of its home network (the network of the operator where the user of the apparatus is subscribed to) it may be forced to select the home network among the available networks. However, when the home network is not reachable (for example if the user of the mobile apparatus travels abroad) a different (non home network) may be selected. For those situations the home network operator may have roaming agreements with selected other network operators in place, and the mobile apparatus may select a network to connect to where a roaming agreement exists.

Therefore a mobile apparatus based network selection may be performed which may be based on pre-defined rules and/or pre-configured network lists provided by the home network operator. However the content of those pre-configured rules/lists may change due to the changing nature of roaming agreements where the rules/lists are based on. Therefore the pre-defined rules and/or pre-configured network lists in the mobile apparatus may be outdated, even if those lists are updated by the home network operator from time to time. Further on updating those rules/lists may be a time and resource consuming process for the home network operator.

When a mobile apparatus has selected one wireless network to connect to, a connection request for the selected (visited) network may be forwarded to the home network. The home network may then either accept or reject the request (for example based on the latest list of permitted networks) and may inform the mobile apparatus about it. If the connection request is rejected the mobile apparatus may select another network from the available ones and may start another connection request towards the home network. This may happen several times until finally a wireless network may be chosen by the mobile apparatus that is accepted by the home network.

However, due to the several connection request attempts the above described network selection process may be time consuming and may generate a lot of signaling traffic before finally an accepted connection might be established. Further on, the by the mobile apparatus selected, and by the home network accepted, network may not be the optimal network in terms of for example performance, offered services, coverage and costs, since the acceptance of the wireless network by the home network may be based on a simple yes/no decision for the by the mobile apparatus pre-selected network (for example based on the fact if a roaming agreement with this network operator is in place or not).

Similar issues might also occur in non roaming cases, for example when the home network operator does not require from the mobile apparatus that it connects to the home network if it is available (for example when a mobile apparatus is close to a country border a foreign network may have a better signal then the home network, the mobile apparatus may select the foreign network instead of the home network.). Further on a similar situation might occur if the mobile apparatus may not have any assigned home network at all or may have more than one assigned home network. In these cases a similar network selection as described above might be done.

### SUMMARY OF THE INVENTION

In consideration of the above, there may be the need to improve delay and/or the amount of signaling traffic during the network selection process.

In particular, the present invention may provide a method, apparatuses and related computer programs for selecting a wireless network at a wireless apparatus. Various aspects of examples of the invention are set out in the claims.

According to an exemplary embodiment of the present invention, in a first aspect, a method may be provided which may select at least one wireless network at a mobile apparatus, the method may comprise detecting available wireless networks at the mobile apparatus, sending a first list which may comprise information of at least a part of the available wireless networks from the mobile apparatus to a network apparatus, electing from the first list at least one wireless network at the network apparatus, transmitting a second list which may comprise the at least one elected wireless network from the network apparatus to the mobile apparatus and performing the network selection at the mobile apparatus where the selection may take the received second list into account.

Further refinements of the first aspect of the present invention may be set out in any of the claims depending from the method according to the first aspect as described above.

According to an exemplary embodiment of the present invention, in a second aspect, a mobile apparatus may be provided which may select at least one wireless network, the mobile apparatus may comprise a detector which may detect wireless networks which may be available at the mobile apparatus, a sender which may send a first list which may comprise information of at least a part of the available wireless networks, a receiver which may receive a second list wherein the second list may comprise at least one elected wireless network and a selector which my select a wireless network where the selection may take the received second list into account.

Further refinements of the second aspect of the present invention may be set out in any of the claims depending from the mobile apparatus according to the second aspect as described above.

According to an exemplary embodiment of the present invention, in a third aspect, a network apparatus may be provided which may support selection of at least one wireless network and may comprise a receiver for receiving a first list which may comprise information of at least a part of available wireless networks at a mobile apparatus, an elector which may elect at least one wireless networks from the first list and a transmitter, which may transmit a second list wherein the second list may comprise of the at least one elected wireless network.

Further refinements of the third aspect of the present invention may be set out in any of the claims depending on the network apparatus according to the third aspect as described above.

According to an exemplary embodiment of the present invention, in a fourth aspect, a system may be provided which may select at least one wireless network and may comprise at least one mobile apparatus according to the second aspect of the invention and at least one network apparatus according to the third aspect of the present invention.

According to an exemplary embodiment of the present invention, in a fifth aspect, a computer program may be provided which may comprise code that may detect wireless networks available at a mobile apparatus, code that may send a first list which may comprise information of at least a part of the available wireless networks, code that my receive a second list which may comprise elected wireless networks wherein the second list may comprise at least one elected wireless network and code that may select at least one wireless network where the selection may take the received second list into account.

According to an exemplary embodiment of the present invention, in a fifth aspect, a computer program may be provided which may comprise code that may receive a first list that may comprise information of at least a part of available wireless networks at a mobile apparatus, code that may elect at least one wireless networks from the received first list of available wireless networks and code that may transmit a second list, which may comprise the at least one elected wireless networks.

Further refinements of the fifth and sixth aspect of the present invention may be set out in claims depending on the computer programs according to the fourth and fifth aspect as described above.

The following paragraphs define certain terms and elements used throughout this application. These definitions are related to the exemplary embodiments of the invention as described below and might not be directly applicable to other, alternative, embodiments of the invention not described within this document.

The term “network selection” or “selecting a wireless network” may cover the selection of a single (wireless) network or the selection of several (wireless) networks. The selection of several (wireless) networks according the present invention may happen either one after another or simultaneously (in parallel). If the selection of several (wireless) networks may happen one after another, the claimed method may be applied several times in a row. If the selection of several (wireless) networks may happen simultaneously (in parallel), the claimed method may be applied only once and the mobile apparatus may select several networks from the second list when performing the network selection. Network selection may happen automatically (done by the mobile apparatus without involving the user of the mobile apparatus) or manually (by the user of the mobile apparatus).

An access network may be a part of a network that may comprise wireless access points and/or base stations where mobile apparatuses may be connected to via a radio interface. Further on an access network might comprise access network controller(s) and/or access network gateway(s) where the access points are connecting to and which may provide interfaces towards a core network. Access networks of different types could be for example GERAN, UTRAN, E-UTRA, CDMA2000 RAN, WLAN or Wimax (note this is just a non-limiting example list which might not be complete).

A core network may be a central part of a telecom network that may provide various services to users which might be connected to the core network via access networks. Several access networks of similar or different types may be connected to one core network. Examples of core network functions are traffic aggregation, authentication, call control, switching & routing, charging, access network selection control and/or support, services and gateway functionality to connect to other networks (for example the Internet).

A network of an operator may comprise of a core network and at least one access network. A different term used for a network of an operator is Public Land Mobile Network (PLMN).

A Non Access Stratum is a functional layer running between a mobile apparatus (user equipment) and a Core Network. The layer supports traffic and signaling messages between the Core Network and the mobile apparatus.

A mobile apparatus may be a mobile phone, a PDA, a portable computer, a pager or any kind of other wireless apparatus that may be connected via a radio interface to a wireless network. A mobile apparatus may have the ability to connect to several wireless networks or access points/base stations in parallel at the same time, which may be based on different technologies. Further on a mobile apparatus may offer manual and/or automatic network selection options.

A network apparatus may be a server located in the core network or in the access network. The server might be a stand-alone equipment (like for example a smart roaming server located in the core network) or might be integrated into another network apparatus (for example to a home location register (HLR)).

The above provided examples of a mobile apparatus and a network apparatus shall be understood as a not limiting list of examples which do not exclude other possible mobile or network apparatuses.

### BRIEF DESCRIPTION OF THE DRAWINGS

For a more complete understanding of exemplary embodiments of the present invention, reference is now made to the following descriptions taken in connection with the accompanying drawings, in which:

FIG. 1 illustrates a first exemplary embodiment of a high level network architecture where the invention might be used; and

FIG. 2 shows a second exemplary embodiment with method steps related to the present invention; and

FIG. 3 shows in a third exemplary embodiment a first table comprising a list of available networks detected at a mobile apparatus of the present invention; and

FIG. 4 presents in a fourth exemplary embodiment a second table comprising a list of at least one elected wireless network elected by a network apparatus of the present invention.

FIG. 5 presents a fifth exemplary embodiment of a block diagram of a mobile apparatus according to an example of the invention; and

FIG. 6 presents a sixth exemplary embodiment of a block diagram of a network apparatus according to an example of the invention; and

FIG. 7 illustrates in a seventh exemplary embodiment a signal flow diagram related to the present invention.

### DETAILED DESCRIPTION OF THE PRESENT INVENTION

Examples of the present invention are described herein below with reference to the accompanying figures.

The described embodiments are not limited to the mentioned networks, network elements, messages and signals.

In general the shown figures relate to exemplary embodiments of the present invention where a mobile apparatus may detect available wireless networks, may report information about detected wireless networks in one form or another (for example as a prioritized, encrypted first list) to a network apparatus. The network apparatus may elect then from the reported information (first list) of available wireless networks wireless networks (for example wireless networks selected or preferred by the network operator), may generate a second list comprising the elected wireless networks (which might be prioritized and/or encrypted) and may send the second list back to the mobile apparatus. The second list may comprise a sub-set of the reported available networks and the second list may comprise of minimum one elected wireless network. The mobile apparatus may use then the received second list and may select one or more of the available and elected wireless networks from the second list and may connect to the selected one or more network(s). The selection may happen automatically (performed by the mobile apparatus without involving the user of the mobile apparatus) or manually by the user of the mobile apparatus. In the manual selection case the mobile apparatus may display the second list (or parts of the content from the second list) visible to the user. The user may then perform the selection of one or more wireless networks based on the displayed content of the second list.

A mobile apparatus may be a mobile terminal adapted for scanning a plurality or all Radio Frequency (RF) channels for example UMTS Terrestrial Radio Access (UTRA) bands depending on the capabilities of the mobile to find available Public Land Mobile Networks (PLMNs). On each carrier, the mobile terminal may search for a strong cell or the strongest cell and may read the system information of that cell in order to find out which PLMN the cell belongs to.

If the mobile terminal can read one or several PLMN identities in the strongest cell, each found PLMN may be reported to the Non Access Stratum (NAS) as a high quality PLMN (maybe without the Received Signal Code Power (RSCP) value), provided that certain conditions may be fulfilled. Found PLMNs that may not satisfy a high quality criterion, but for which the mobile terminal has been able to read the PLMN identities may be reported to the NAS together with the Common Pilot Channel (CPICH) RSCP value for UTRA Frequency Division Duplexing (FDD) cells and Common Control Physical Channel (P-CCPCH) RSCP for UTRA Time Division Duplexing (TDD) cells.

The quality measure which may be reported by the mobile terminal to NAS may be the same for each PLMN found in one cell. The search for PLMNs on the rest of the carriers may be stopped on request of the NAS. Thus, information about the available PLMNs may be available in the NAS of the mobile terminal, in form of a list of high quality PLMNs and “other” PLMNs along with signal level measurements.

Based on this information, in addition to information about registered PLMN, user and operator may specify PLMN lists and forbidden PLMNs list. The NAS may select one PLMN and may attempt a location and/or routing area registration. Mobility Management (MM) Location Update and/or GSM Mobility

Management (GMM) Routing Area Update message may comprise a list of detected PLMNs.

The receiving Visitor Location Register (VLR)/Serving GPRS Support Node (SGSN), which might be located between the mobile terminal and the home network, may map the PLMN list into the MAP Update Location request and/or Mobile Application Part (MAP) Update General Packet Radio Service (GPRS) Location request sent to the home network, for example the HLR or a smart roaming server of the home network. In order to protect the integrity of the information sent, the PLMN list may be encrypted by using available security key information. Encryption and decryption may happen at the mobile terminal and/or the network element receiving the information, for example the HLR.

HLR or smart roaming server may use the received PLMN list, along with a list of preferred networks (for example preferred by the network operator) and possibly the subscribed services to decide whether to accept or reject the registration/s. The decision logic may be operator configurable. An example of a possible logic, in case of automatic selection, might be: if the selected PLMN is in the preferred network list, a grant of the registration may be performed; in case none of the reported PLMNs (taking also the selected one into account) is a preferred network, then a grant of the location registration (higher priority PLMN selection might be performed by the terminal anyway) may be performed; if the selected PLMN is not a preferred networks but one/more than one of the reported PLMNs is in the preferred PLMNs list, then a rejection of the registration and insertion of the preferred PLMN id in the MAP Update Location response and/or MAP Update GPRS Location response messages may be performed.

The VLR/SGSN may then map the information in for example a GMM Routing Area Update reject message. The terminal may implement an appropriate logic to take the network indication into account and may retry the registration via the home network preferred Visited Public Land Mobile Network (VPLMN).

In case of manual selection, a logic in the network may be available to handle terminal requests trying to select PLMNs without following the home network indication (e.g. trying to convince the subscriber by providing pricing information). The Subscriber Identity Module (SIM) Management and/or Roaming server may use the input to decide on the priority for the preferred PLMNs before provisioning the list to the terminal. Provisioning may be performed for example Over The Air (OTA).

Delays in the registration procedure due to unnecessary rejections of the registration might be avoided; it may be guaranteed that the mobile terminal/end user selects not only the most cost efficient PLMN but also a PLMN with high quality coverage.

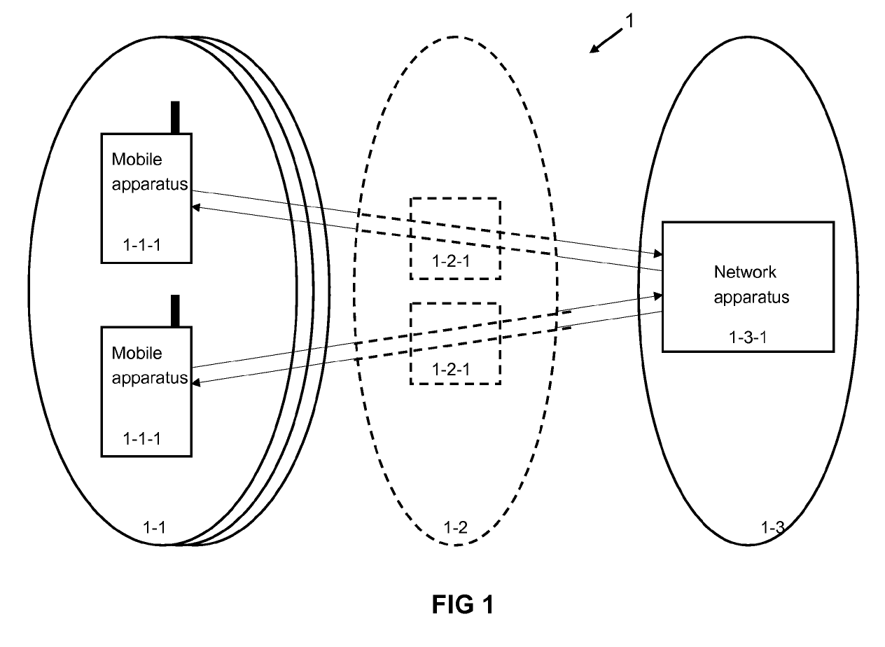

FIG. 1 shows as a first exemplary embodiment of the present invention a high level system 1, where mobile devices 1-1-1 are located in the range of at least one network 1-1 and are communicating with a network apparatus 1-3-1 located in a different network 1-3. This could be for example the case when the mobile apparatus 1-1-1 is roaming in a visited network 1-1, while the network apparatus 1-3-1 is located in the home network 1-3 of the mobile apparatus 1-1-1. However, the mobile apparatus 1-1-1 and the network apparatus 1-3-1 might be also located and/or in the range of the same network (not shown in FIG. 1). If the mobile apparatus 1-1-1 and the network apparatus 1-3-1 are located/in the range of different networks 1-1 and 1-3, the communication between those apparatuses might traverse one or more intermediate networks 1-2 where the signaling messages might be converted/inter-worked by network elements 1-2-1 located in the intermediate network(s) 1-2. A conversion of signaling messages might also happen in network elements located in the networks 1-1 or 1-3 where the mobile apparatus 1-1-1 or the network apparatus 1-3-1 are located (for example in a VLR or SGSN in network 1-1; this is not shown in FIG. 1).

In order to establish or maintain one or more existing connection(s) the mobile devices 1-1-1 may be connected to at least one of the available wireless networks 1-1. The mobile apparatus may perform measurements in order to detect the available wireless networks 1-1. Such measurement(s) might be done by performing a frequency scanning process at the mobile apparatus and collecting various information about each available network, like for example network name, network identification, receive signal strength and measured frequency. The measurement(s) might be triggered for example by the user of the mobile apparatus, the mobile apparatus 1-1-1 itself, a network apparatus 1-3-1, the operator of network 1-3 where the network apparatus 1-3-1 belongs to or by one of the available wireless networks (for example if a connection to one network exists already). Reasons for triggering a measurement might be for example setting up of a new connection or maintaining of an ongoing session while for example leaving the coverage area of the network where the mobile apparatus is presently connected to.

When the measurements (for example one frequency scanning cycle) are done the found wireless networks (or at least a part of the found wireless networks) may be reported from the mobile apparatus 1-1-1 to a network apparatus 1-3-1. The reporting could be done in a form of a first list 3 comprising information about the available wireless networks. Such a first list might be prioritized and for security reasons encrypted (for example to ensure that the content of the first list cannot be modified by intermediate equipment like 1-2-1 where the information exchanged between the mobile apparatus 1-1-1 and the network apparatus 1-3-1 might be passing through).

After receiving the first list from the mobile apparatus 1-1-1 at the network apparatus 1-3-1, the network apparatus 1-3-1 may decode the first list 3 (if it is encoded) and may process the information from the first list. The network apparatus may elect then the wireless networks from the first list (at least one available wireless network may be elected) and generates a second list of elected wireless network(s), might prioritize the elected wireless networks (if more than one is elected) and might encrypt the second list (for the same reasons as mentioned above) before the second list may be transmitted to the mobile apparatus. The election process might be influenced by the mobile apparatus 1-1-1 indicated priorities of the available wireless networks, by rules and preferences configured in the network apparatus 1-3-1 (for example provided by the network operator) or by a combination of both. Finally the second list may be transmitted to the mobile apparatus 1-1-1, which may then decode the received second list and may use the comprised information for finally selecting one or more network(s) where to connect to. The selection might be done automatically by the mobile apparatus 1-1-1 or manually by the user of the mobile apparatus.

In order to be able to transmit the information in relation to the available wireless networks from the mobile apparatus 1-1-1 to the network apparatus 1-3-1, the mobile apparatus 1-3-1 might establish a temporary network connection with one of the available wireless networks 1-1. The temporarily selected wireless network might be then reported (for example together with the first list of the available wireless networks) to the network apparatus 1-3-1, as well as the way how the temporary network has been selected (for example manually or automatically). The network apparatus 1-3-1 might then either accept or reject the temporary selected wireless network and might reply, together with the rejection/acceptation information/message, the second list which may comprise the at least one elected wireless network to support the selection of a different wireless network at the mobile apparatus 1-1-1.

In addition to the second list the reply, informing the mobile apparatus 1-1-1 about the rejection/acceptation of the connection, might include also information about the reasons. For example in case of a rejection the networks comprised now in the second list may provide lower price or better coverage compared to the earlier selected, now rejected, network. This might be useful if for example the selection of the now rejected network was done manually by the user of the mobile apparatus, so that the user might be informed now why his selection was rejected. Alternatively, information why the connection was rejected or accepted might be provided by an external system (for example a Short Message Service Centre—SMSC) which might be triggered by the rejection/acceptation action to send the information comprising the reasons to the mobile apparatus.

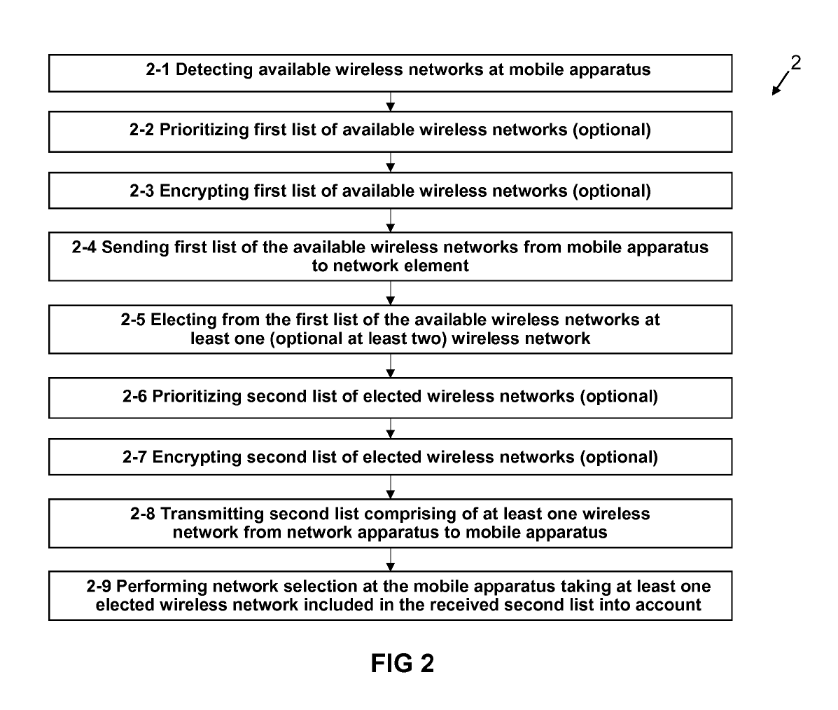

FIG. 2 shows a second exemplary embodiment of the present invention in form of a flow diagram illustrating a method according to an example of the invention.

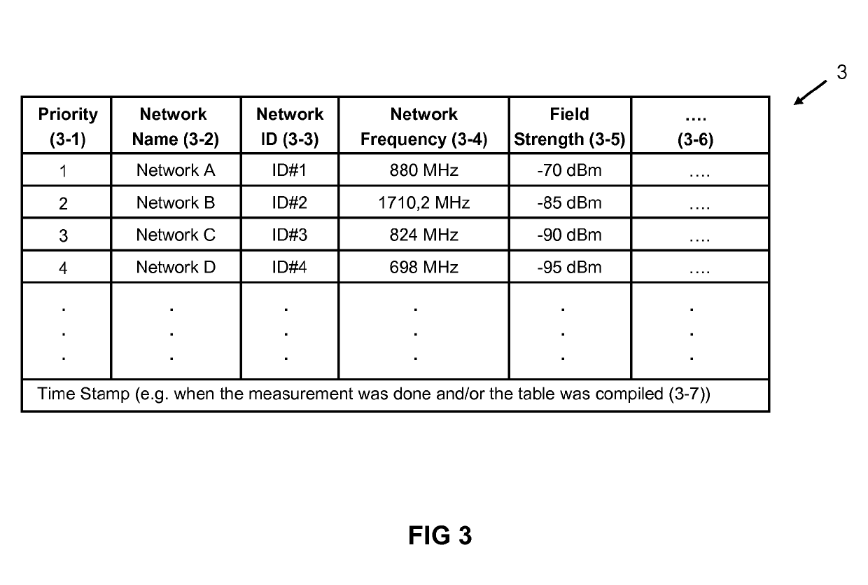

In a first step 2-1 of the method in FIG. 2 a mobile apparatus may detect available wireless networks in its reach. This may be done by performing a frequency scan over the whole, or parts, of the supported spectrum and collecting information about the available (found) wireless networks (for example network name, network identifier, received field strength, network frequency, available capacity, network performance, etc.). The frequency scan might happen periodically, on demand or in irregular intervals and might be triggered by the user of the mobile apparatus, the mobile apparatus itself or by one of the available wireless networks (for example if an ongoing session shall be maintained while the mobile apparatus leaves the coverage area of the currently connected network). The measurement results may be collected in a first table/list as shown in FIG. 3. The first list may comprise information about all found/detected wireless networks or only a sub-set (for example only the wireless networks where the measured received field strength exceeds a certain threshold). Optionally the measurements itself or the whole first table/list might be time stamped in order to indicate when the measurement(s) were performed.

In a second optional step 2-2 of the method in FIG. 2 the list of available wireless networks found during the detection in step 2-1 may be prioritized by the mobile apparatus. Such a prioritization might be done for example by using the measured receive field strength, other information collected during the performed measurements in step 2-1 (for example supported bandwidth/services) or by taking configured rules or lists in the mobile apparatus into account which might have been pre-programmed.

Once the first list has been prioritized a connection to one of the available wireless networks may be established (not shown in FIG. 2, only done if no connection exists so far) in order to be able to send the first list.

In a third optional step 2-3 of the method in FIG. 2 the first list may be encrypted in order to avoid that the content of the first list might be manipulated by for example intermediate network elements (1-2-1 in FIG. 1) when sending the first list in step 2-4. The encryption may happen for example by using keys received and/or generated during the connection set-up phase. Alternatively the keys may be stored permanently in the mobile apparatus, for example in the SIM comprised in the mobile apparatus.

In a fourth step 2-4 of the method in FIG. 2 the first list comprising information about available wireless networks may be sent in a message from the mobile apparatus to a network apparatus. The network apparatus might be located in the network where the mobile apparatus is connected to, or might be located in a different network. In the later case the mobile apparatus might be for example located in a visited network while the network apparatus might be located in the home network of the mobile apparatus. There might be even further networks located between the mobile and the network apparatus where the message might be passed through (see for example FIG. 1 network 1-2). The message might be a dedicated message for the purpose to transfer the first list or it might be a standard message which is extended to comprise the first list. Preferably a “Connection Request” message (for example a “RRC Connection Request” message), a “Channel Request” message (for example a “RR Channel Request”), a “Location Update Request” message (for example “MM Location Update Request” message) or a “Routing Area Update Request” message (for example “GMM Routing Area Update Request” message) might be used.

The message used to transfer the first list from the mobile apparatus to the network apparatus might be converted, interworked or re-mapped to another message at certain apparatus(ses) where it might be passing through (for example apparatus 1-2-1 in FIG. 1). However at least the first list, which might comprise the information about available wireless networks, might be re-mapped to a new message and passed further on. This could be performed for example in the VLR or SGSN (1-2-1) which could receive for example a “Location Update Request” message or a “Routing Area Update Request” message, might extract the first list from those messages and map it for example to a “Update Location Request” message (for example a “MAP_UPDATE_LOCATION request” message or a “MAP_UPDATE_GPRS_LOCATION request” message) or a “Send Authentication Info Request” message (for example a “MAP_SEND_AUTHENTICATION_INFO request” message) which might be then forwarded to a server, for example a smart roaming server or a HLR.

The network apparatus receiving the first list may be preferably located in a core network, but might be also located in an access network. The network apparatus might be a server (for example a smart roaming server). Furthermore the network apparatus might be another network device which might comprise smart roaming server functionality.

When the network apparatus receives the message comprising the first list it optionally may decode the first list (not shown) if it was encoded by the mobile apparatus. The message received by the network apparatus might be for example an “Location Update Request” message, an “Routing Area Update Request”, a “Connection Request” message, a

“Channel Request” message, an “Update Location Request” message or a “Send Authentication Info Request” message.

In a fifth step 2-5 of the method in FIG. 2 the network apparatus may elect from the received first list at least one wireless network (optionally at least two wireless networks are elected). The elected wireless networks might be collected in a second list, also called elected list. Criteria for the election might be the received information in relation to the available wireless networks at the mobile apparatus extracted from the received first list and/or further rules and criteria which may be available at the network apparatus. Those rules or criteria might be for example preprogrammed by the network operator and might reflect for example required network preference for the requested service by the mobile apparatus or network preferences in order to reduce costs and/or improve network performance.

In an optional sixth step 2-6 of the method in FIG. 2 the entries in the second list might be prioritized (if more than one wireless networks has been elected). Prioritization might happen based on the same criteria used for example for electing the wireless network(s).

In a further optional seventh step 2-7 of the method in FIG. 2 the second list might be encrypted for the same reasons as mentioned already for step 2-3. The encryption may happen for example by using keys received and/or generated during the connection set-up phase. Alternatively the keys may be stored permanently in the network apparatus.

In an eight step 2-8 of the method in FIG. 2 the second (elected) list might by transmitted from the network apparatus to the mobile apparatus. Like mentioned for step 2-4 mobile and network apparatuses might be located in the same or in different networks, and there might be other networks in-between. The messages that may be used to transmit the second (elected) list might be either dedicated or standard messages. Preferably an “Update Location Response” message (for example a “MAP_UPDATE_LOCATION response” message or a “MAP_UPDATE_GPRS_LOCATION response” message), an “Insert Subscriber Data Request” message (for example “MAP_INSERT_SUBSCRIBER_DATA request” message), a “Connection Setup” message (for example a “RRC Connection Setup” message), a “Immediate Assignment” message (for example a “RR Immediate Assignment” message), a “Connection Release” message (for example a “RRC Connection Release” message), a “Channel Release” message (for example a “RR Channel Release” message), a “Connection Reject” message (for example a “RRC Connection Reject” message) or an “Immediate Assignment Reject” message (for example a “RR Immediate Assignment Reject” message) is used.

The message used to transfer the second (elected) list from the network apparatus to the mobile apparatus might be converted, interworked or re-mapped to another message at certain devices where it is passing through. However at least the second list may be re-mapped to the new message and passed further on. This might happen for example in a VLR or SGSN which could receive for example a “Update Location Response” message or an “Insert Subscriber Data Request” message, might extract the second (elected) list from the message and might map it for example to a “Routing Area Update Reject” message (for example a “GMM Routing Area Update Reject” message), a “Routing Area Update Accept” message (for example a “GMM Routing Area Update Accept” message), a “Location Update Reject” message (for example a “MM Location Update Reject” message), a “Location Update Accept” message (for example a “MM Location Update Accept” message), or an “Authentication Request” message (for example a “MM Authentication Request” message) which might be then forwarded to the mobile apparatus.

The mobile apparatus might receive the message comprising the second list. The received message might be a “Routing Area Update Reject” message, a “Routing Area Update Accept” message, a “Location Update Reject”, a “Location Update Accept” message, an “Authentication Request” message, a “Connection Setup” message, an “Immediate Assignment” message, a “Connection Release” message, a “Channel Release” message, a “Connection Reject” message or an “Immediate Assignment Reject” message.

The mobile apparatus optionally decrypts the second list (if needed—not shown), and might display the second list, or at least part of the content of the second list, to the user of the mobile apparatus (not shown, this is useful if the network selection is done manually by the user of the mobile apparatus).

In a ninth step 2-9 of the method in FIG. 2 the mobile apparatus might perform network selection of one or more wireless networks which might take at least one wireless network from the received second (elected) list into account (for example the list entry with the highest priority, however it could be also another entry depending for example on the current situation of the available networks at the mobile apparatus and/or the needs of the mobile apparatus like for example the required services). The network selection might happen automatically or manually (for example if the selection might be done by the user of the mobile apparatus).

FIG. 3 shows an exemplary embodiment illustrating how the content of a first list 3, which may comprise information about available wireless networks detected by a mobile apparatus and which may be transferred to a network apparatus, may look like. In this example an optional priority column 3-1 is shown. In addition the first list 3 may comprise columns for the network name 3-2, the network identifier 3-3, the frequency of the network 3-4 and the received field strength 3-5. Column 3-6 is a placeholder for further information that might be part of the first list (for example available services, supported capacity, current network load, cell ID, mobile country code (MCC) or mobile network code (MNC), etc.).

The information to be measured by the mobile apparatus and/or the data to be part of the first list 3 may be either pre-configured in the mobile apparatus or configurable via different means (for example via SMS, network management, network signaling, the home network operator, user interface or via the connected access network).

For each detected wireless network, which may be reported in the list (as mentioned in connection with the description related to FIG. 2 not all found/detected wireless networks may become part of the list), one row may be added with information related to the network. In addition an optional field 3-7 at the end of the first list may be foreseen, for example for a time stamp which may identify when the first list was generated or when the measurements were done. Alternatively to a common timestamp field for the whole first list a time stamp column might be foreseen allowing to timestamp each individual entry of the found/detected wireless networks. Further (not shown) examples about common information which might be part of such a first list 3 are mobile apparatus related information like mobile apparatus identification (ID), position of the mobile apparatus (for example GPS information), country where the mobile apparatus is located, visited network(s) where the mobile apparatus is currently connected to, etc.).

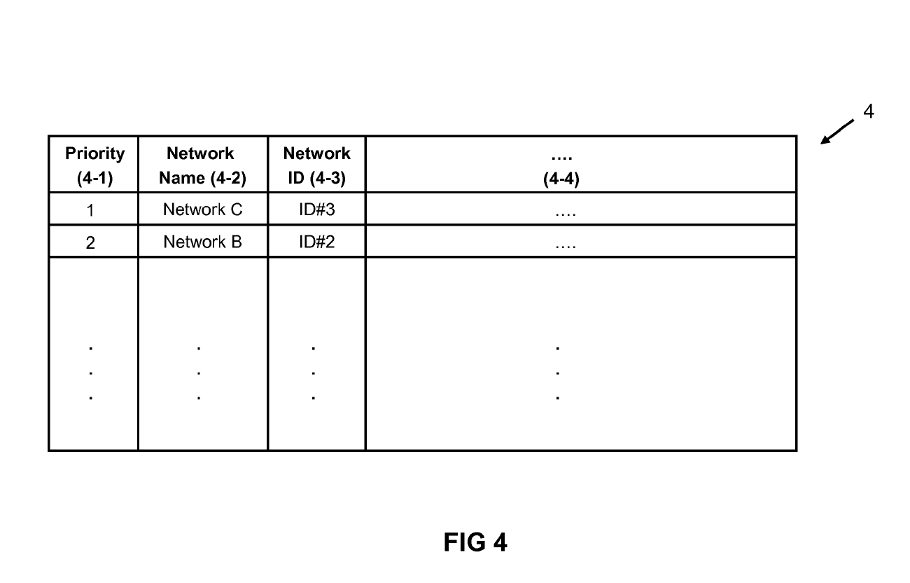

FIG. 4 shows an exemplary embodiment outlining how the content of a second (elected) list 4, which may be transmitted from the network apparatus to the mobile apparatus, may look like. In this example an optional priority column 4-1 is shown. In addition, the second list may comprise columns for the network name 4-2, the network identifier 4-3 and for further information (column 4-4). There might be one row with the information of each elected wireless network.

The exemplary embodiments in FIG. 3 and FIG. 4 show that four detected networks may be reported by the mobile apparatus (see first list 3 networks A, B, C and D). From second (elected) list 4 it is visible that Networks C and B may be elected by the network apparatus, while network C might be prioritized before network B. If the mobile apparatus may follow the priority order shown in the second list 4 given by the network apparatus, the mobile apparatus may select network C and connect to it (if it is not connected to network C already earlier).

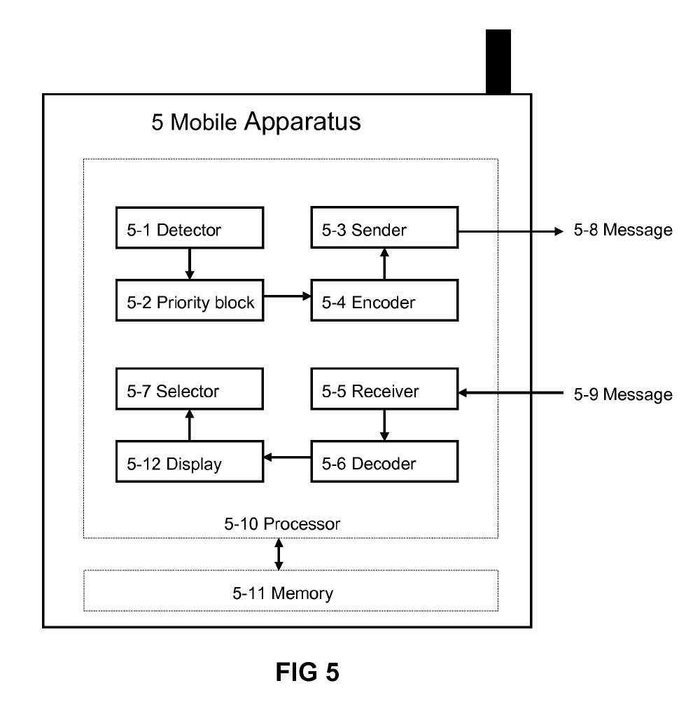

FIG. 5 shows as a fifth exemplary embodiment of the present invention comprising details of a mobile apparatus 5.

The mobile apparatus 5 in FIG. 5 may comprise a detector 5-1 which may detect the available wireless networks at the mobile apparatus 5. The detection may be performed periodically, at one or more defined time point(s) or it might be triggered by for example the user of the mobile apparatus 5 or the network where the mobile apparatus 5 might be currently connected to. Information about the detected wireless networks might be collected in a first list. Not all detected networks might be part of the first list, for example only detected wireless networks exceeding a defined receive level threshold may be added to the first list. Optionally the first list, or each entry in the list, might be time stamped, for example with the time when the measurement was performed or when the first list was generated.

The mobile apparatus 5 in FIG. 5 may further comprise an optional priority block 5-2, which might prioritize the detected wireless networks in the first list 3. Such a prioritization may be performed according to one or more different criteria, for example the receive level, the supported services and/or the available capacity of the detected wireless networks.

Moreover, the mobile apparatus 5 in FIG. 5 may comprise an optional encoder 5-4, which is encrypting the first list 3 provided for example by the decoder 5-1 or the priority block 5-2. The encryption of the first list 3 may be performed before the first list 3 is transmitted through the network in order to ensure that entries in the first list 3 might not be changed by intermediate network elements. For the encryption an encryption key might be used which might be pre-configured or might be generated when the mobile apparatus has connected to the network it is currently using.

The sender 5-3 of the mobile apparatus 5 in FIG. 5 may then send the first list (which might be optionally prioritized and/or encrypted as outlined above) towards a network apparatus supporting the network selection process. The transmission of the list might happen via a message 5-8, which might be a dedicated message generated by the sender 5-3 for sending the list or may be a message used for a different purpose where the information of the first list 3 may be added to (for example a “Location Update request” message, a “Routing Area Update request” message, a “Connection Request” message or a “Channel Request” message).

If the mobile apparatus 5 is not connected to any wireless network yet it may connect to one wireless network before sending the first list 3. The connection may be a temporary connection and the first list 3 might be sent in a connection request message which may be sent together with the first list to the network apparatus.

The network apparatus may return or send back a modified second list 4 (the so called “elected list”) via message 5-9. The mobile apparatus 5 may receive message 5-9 via the receiver 5-5. The receiver 5-5 my further extract the second (elected) list information from the message 5-9, which might be a dedicated message for carrying the second list 4 or an other message where the selected list has been added to (for example a “Routing Area Update Reject” message, a “Routing Area Update Accept” message, a “Location Update Reject”, a “Location Update Accept” message, an “Authentication Request” message, a “Connection Setup” message, an “Immediate Assignment” message, a “Connection Release” message, a “Channel Release” message, a “Connection Reject” message or an “Immediate Assignment Reject” message). Message 5-9 may include information about the reasons why a connection request of the mobile apparatus 5 was rejected or accepted.

If the received second (elected) list 4 is encrypted it may be passed to the decoder 5-6 (the decoder is optionally since the received second list 4 might be also not encrypted). The decoder 5-6 decrypt then the second list.

Optionally at least parts of the content of the received second list may be displayed via a display block 5-12 to the user of the mobile apparatus (this may be useful in manual network selection mode so that the user is informed about the selection options which might be accepted by the network). Optionally the reasons for a possible rejection or acceptation of a connection request may be displayed via the display 5-12 to the user.

Finally the second list may be passed to a selector 5-7 in the mobile apparatus where a network selection of one or more wireless network(s) may be done taking the received information in the second (elected) list into account. It should be noted, that the decision about the network selection might not be solely based on the received second list information, in addition also available information at the mobile apparatus might be taken into account when performing the selection (this might be needed if the situation at the mobile apparatus has changed since the list of detected available networks has been generated, for example if a network on the second list has disappeared or degraded). After the selector 5-7 might have selected one or more of the available wireless network(s) the mobile apparatus 5 may connect to the selected network(s) if not connected to it/them already). If necessary the mobile apparatus may disconnect from one or more network(s) where it is currently connected to, which may happen before connecting to the one or more selected network. The selection might be done automatically by the mobile apparatus, or manually by the user of the mobile apparatus.

Further details about the functionality of the sub-blocks of the mobile apparatus 5 or the messages 6-7 or 6-8 are described in connection with the related steps of FIG. 2.

Further on functionality of the sub-blocks 5-1 to 5-7 and 5-12 of the mobile apparatus 5 in FIG. 5 might be implemented at least partly using a processor 5-10. The processor 5-10, as well as related memory 5-11, might be then part of the mobile apparatus 5.

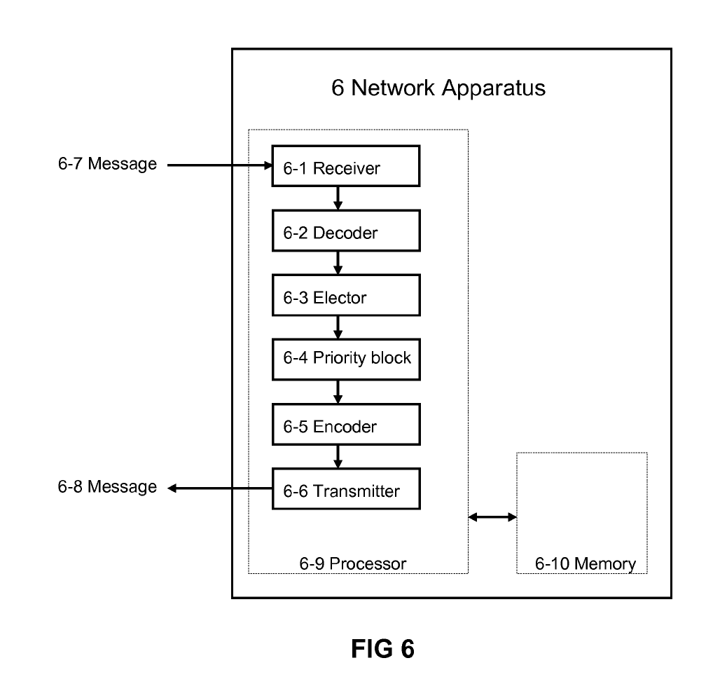

FIG. 6 shows a sixth exemplary embodiment of the present invention which illustrates details of a network apparatus 6.

The network apparatus 6 in FIG. 6 may comprise a receiver 6-1 which may receive via message 6-7 a first list 3 which might comprise information about available networks generated by a mobile apparatus 5 for example in a form of a first list. The message 6-7 might be either a dedicated message for transferring the first list 3 or a message which may be already used for a different purpose and where the first list information might have been added to (for example a “Location Update Request” message, a “Routing Area Update Request” message, a “Connection Request” message, a “Channel Request” message, an “Update Location Request” message or a “Send Authentication Info Request” message). If the first list 3 may be mapped to an existing message 6-7 the receiver 6-1 may extract the first list from the message 6-7.

If the received/extracted first list 3 is encrypted it may be passed to a decoder 6-2 which may decrypts the first list (the decoder 6-2 is an optional element of the network apparatus since the first list might be also not encrypted).

Next the first list may be passed (directly from the receiver 6-1 or via the decoder 6-2) to an elector 6-3 of the network apparatus 6 in FIG. 6. The elector may read the information from the first list 3, may process the information and may elect at least one wireless network from the first list 3. In addition to the information that may be provided in the received first list 3, the election process might also take pre-defined rules and/or network preferences, stored for example in the network apparatus 6, into account when electing the at least one wireless network.

Alternatively also information or rules provided by other network elements or by the network operator may be taken into account when performing the election process. As a result from the election process at least one of the wireless networks in the first list 3 is elected (preferable at least two wireless networks are elected). Once the election process has been completed, a second (elected) list, which may comprise information about the elected one or more wireless network(s), might be generated by the elector 6-3.

If more than one network may be elected the second list 3 might be passed to a priority block 6-4 of the network apparatus 6 in FIG. 6, which might prioritize the elected wireless networks in the second list. Prioritization is optional and might be performed based on various criteria (for example based on the attributes of the elected wireless networks received from the mobile apparatus via the available network list 3, or via criteria pre-configured in the network apparatus or configured by the network operator).

Next the second (elected) list (either from the elector 6-3 or from the priority block 6-4) may be passed to an optional encoder 6-5 which might encrypt the second list so that it might not be modified by intermediate network elements where it might pass through when it might be transmitted to the mobile apparatus. Encryption of the second list is optional, encryption key(s) might be shared between the mobile apparatus and the network apparatus, for example when a connection between them is established, or they might be pre-programmed.

Finally the optionally encrypted and prioritized second (elected) list 4 might be passed to a transmitter 6-6 of the network apparatus 6 in FIG. 6 which might transmit the second list towards the mobile apparatus via message 6-8. Message 6-8 might be a dedicated message for transmitting the second list or it might be an already existing message where the second list is added to (for example an “Update Location Response” message, an “Insert Subscriber Data Request” message, a “Connection Setup” message, an “Immediate Assignment” message, a “Connection Release” message, a “Channel Release” message, a “Connection Reject” message or an “Immediate Assignment Reject” message).

Further details about the functionality of the sub-blocks of the network apparatus 6 in FIG. 6 or the messages 6-7 or 6-8 are described in connection with the related steps of FIG. 2.

Further on functionality of the sub-blocks 6-1 to 6-6 of the network apparatus 6 might be implemented at least partly using a processor 6-9. The processor 6-9, as well as related memory 6-10, might be part of the network apparatus 6.

The given order of the sub-blocks and the connections shown between the sub-blocks in FIG. 5 and FIG. 6 should be understood as not limiting, since the order of the sub-block might be changed or some of the sub-blocks might be even left away (for example the optional ones). Furthermore, information might be also passed between not adjacent sub-block (for example when bypassing sub-blocks in-between).

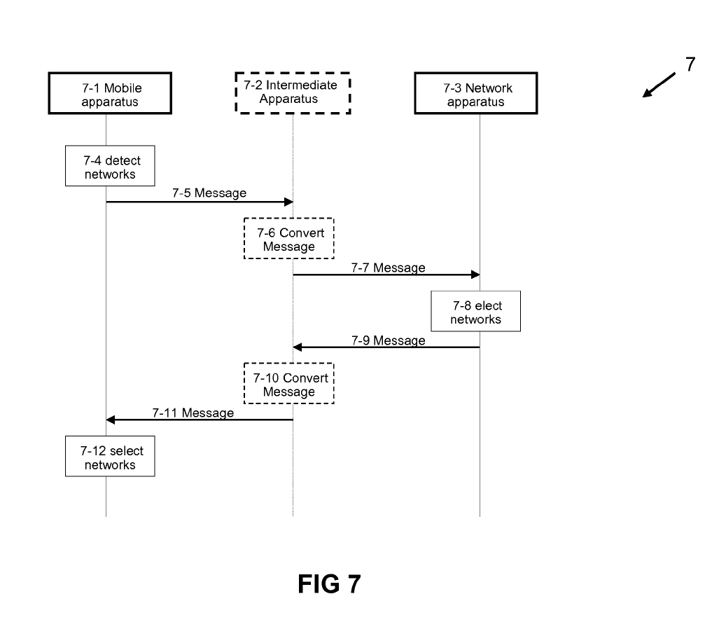

FIG. 7 shows a seventh exemplary embodiment of the invention in form of a high level message flow diagram between a mobile apparatus 7-1 and a network apparatus 7-3 with an optional intermediate apparatus 7-2. As described above in relation to FIG. 1 the mobile apparatus 7-1 might be located in a visited network while the network apparatus 7-3 might be located in the home network of the mobile apparatus 7-1. The intermediate apparatus 7-2 might be located either in the home or in the visited network, or in a network in-between.

The mobile apparatus 7-1 may perform a network detection 7-4 and may generate a message 7-5 for sending information about the detected networks (or a sub-set of the detected networks that may fulfill certain criteria) to the network apparatus 7-3. The information might be sent in message 7-5 as a first list which might be prioritized and/or encrypted (not shown).

Message 7-5 might be received by an intermediate apparatus 7-2 which may convert 7-6 message 7-5 to message 7-7, which may be then forwarded to the network apparatus 7-3. During the conversion 7-6 the first list in message 7-5 may be remapped and/or converted into message 7-7.

Network apparatus 7-3 may then receive message 7-7 and network apparatus 7-3 may extract the first list and might perform an election process 7-8 out of the networks in the first list. The elected networks are then mapped as an second (elected) list, comprising at least one elected network, to a message 7-9. Optionally the second (elected) list might be prioritized and/or encrypted (not shown) before the second list might be transmitted via message 7-9 back to the mobile apparatus 7-1.

Again an intermediate network 7-2 might be passed where the message 7-9 might be converted 7-10 to message 7-11. Message 7-11 together with the second list might be then forwarded to the mobile apparatus 7-1, which may receive the second (elected) list, may extract the second list and may use the content of the second list to perform a network selection 7-12 and connect to the selected network (not shown).

The signaling diagram shown in FIG. 7 is an example diagram showing only some signaling messages related to the invention.

Time aspects of FIGS. 1 to 7 do not restrict any one of the shown steps to be limited to the step sequence as outlined. This applies in particular to method steps that may be functionally disjunctive with each other.

If desired, the different functions or (sub)-blocks discussed herein may be performed in a different order and/or concurrently with each other. Furthermore, if desired, one or more of the above-described functions may be optional or may be combined.

Embodiments of the present invention may be implemented in software, hardware, application logic or a combination of software, hardware and application logic. The software, application logic and/or hardware may reside on a mobile apparatus (or a module being part of the mobile apparatus) and/or on a network apparatus (or a module being part of the network apparatus). In an exemplary embodiment, the application logic, software or an instruction set is maintained on any one of various conventional computer-readable medium. In the context of this document, a “computer-readable medium” may be any media or means that can contain, store, communicate, propagate or transport the instructions for use by or in connection with an instructions execution system apparatus, or device, such as a computer, with examples of a computer (comprising at least of one processor and memory) as shown in FIGS. 5 and 6. A computer-readable medium may comprise a computer-readable storage medium that may be any media or means that can continue or store the instructions for use by or in connection with an instruction execution system, apparatus, or device, such as a computer.

The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembier.

Generally, any method step is suitable to be implemented as software or by hardware without changing the idea of the invention in terms of the functionality implemented.

Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

Devices, apparatuses, units or means can be implemented as individual devices, apparatuses, units or means, but this does not exclude that they are implemented in a distributed fashion throughout the system, as long as the functionality of the device, apparatus, unit or means is preserved.

An apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor.

A device may be regarded as an apparatus or as an assembly of more than one apparatus, whether functionally in cooperation with each other or functionally independently of each other but in a same device housing, for example.

Without in any way limiting the scope, interpretation, or application of the claims appearing below, a technical effect of one or more of the exemplary embodiments disclosed herein may be that a network selection with reduced delay and/or reduced amount of generated signaling traffic might be achieved. Another technical effect of one or more of the exemplary embodiments disclosed herein may be that a network might be selected that fits best to the needs of the network operator and/or the needs of the user of the mobile apparatus, like for example with respect to required services, network coverage, network performance or generated costs. Still a further technical effect of one or more of the exemplary embodiments disclosed herein may be that the in the state of the art needed pre-configuration of rules and/or network selection lists in the mobile apparatus, and keeping those lists up-to-date, might be eliminated.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes exemplary embodiments of the invention, these descriptions should not be viewed in a limiting sense. Rather, there are several variations and modifications which may be made without departing from the scope of the present invention as defined in the appended claims.

Reference signs in the claims are given to show how the claims could be matched to the exemplary embodiments and are not limiting the scope of protection of the claims.

### LIST OF ABBREVIATIONS

CDMA Code Division Multiple Access

CPICH Common Pilot Channel

FDD Frequency Division Duplexing

GERAN GSM Radio Access Network

GMM GSM Mobility Management

GPRS General Packet Radio Service

GPS Global Positioning System

GSM Global System for Mobile communication

HLR Home Location Register

ID Identification

LTE Long Term Evolution

MAP Mobile Application Part

MCC Mobile Country Code

MNC Mobile Network Code

MM Mobility Management

NAS Non Access Stratum

OTA Over The Air

P-CCPCH Common Control Physical Channel

RF Radio Frequency

PLMN Public Land Mobile Network

RSCP Received Signal Code Power

SAE System Architecture Evolution

SGSN Serving GPRS Support Node

SIM Subscriber Identity Module

SMSC Short Message Service Centre

TDD Time Division Duplexing

UMTS Universal Mobile Telecommunications System

UTRA UMTS Terrestrial Radio Access

UTRAN UMTS Terrestrial Radio Access Network

VPLM Visited Public Land Mobile Network

E-UTRAN Evolved UMTS Terrestrial Radio Access Network

VLR Visitor Location Register

WIMAX Worldwide Interoperability for Microwave Access

WLAN Wireless Local Area Networks

1-32. (canceled)

33. A method for selecting at least one wireless network via a mobile apparatus, which comprises the steps of:
detecting available wireless networks at the mobile apparatus;
sending a first list containing information of at least a part of the available wireless networks from the mobile apparatus to a network apparatus;
electing from the first list at least one elected wireless network at the network apparatus;
transmitting a second list, containing the at least one elected wireless network from the network apparatus, to the mobile apparatus; and
performing a network selection via the mobile apparatus taking the second list into account.

34. The method according to claim 33, which further comprises electing at least two elected wireless networks via the network apparatus.

35. The method according to claim 34, which further comprises prioritizing the elected wireless networks in the second list before the second list is transmitted from the network apparatus to the mobile apparatus.

36. The method according to claim 33, which further comprises encrypting the second list before the second list is transmitted from the network apparatus to the mobile apparatus.

37. The method according to claim 33, which further comprises prioritizing the available wireless networks in the first list before the first list is sent from the mobile apparatus to the network apparatus.

38. The method according to claim 33, which further comprises encrypting the first list before the first list is sent from the mobile apparatus to the network apparatus.

39. The method according to claim 33, which further comprises providing the first list with at least one time stamp.

40. The method according to claim 33, wherein the mobile apparatus is roaming in a visited network and the network apparatus is located in a home network of the mobile apparatus.

41. The method according to claim 33, which further comprises sending the first list from the mobile apparatus to the network apparatus in one of a “Location Update Request” message, a “Routing Area Update Request” message, a “Connection Request” message, a “Channel Request” message, an “Update Location Request” message or a “Send Authentication Info Request” message.

42. The method according to claim 33, which further comprises transmitting the second list from the network apparatus to the mobile apparatus in one of a “Update Location Response” message, an “Insert Subscriber Data Request” message, a “Routing Area Update Reject” message, a “Routing Area Update Accept” message, a “Location Update Reject”, a “Location Update Accept” message, an “Authentication Request” message, a “Connection Setup” message, an “Immediate Assignment” message, a “Connection Release” message, a “Channel Release” message, a “Connection Reject” message or an “Immediate Assignment Reject” message.

43. A mobile apparatus for selecting at least one wireless network at the mobile apparatus, the mobile apparatus, comprising:
a detector for detecting available wireless networks available at the mobile apparatus;
a sender for sending a first list containing information on at least a part of the available wireless networks;
a receiver for receiving a second list containing at least one elected wireless network; and
a selector for selecting a wireless network taking the second list into account.

44. The mobile apparatus according to claim 43, further comprising a priority block for prioritizing the available wireless networks in the first list before sending the first list to a network apparatus.

45. The mobile apparatus according to claim 43, further comprising an encoder encrypting the first list before sending the first list to a network apparatus.

46. The mobile apparatus according to claim 43, further comprising a decoder for decrypting the second list.

47. The mobile apparatus according to claim 43, further comprising a display for displaying at least one part of the second list to a user of the mobile apparatus.

48. The mobile apparatus according to claim 43, wherein the first list contains at least one time stamp.

49. The mobile apparatus according to claim 43, wherein the mobile apparatus is roaming in a visited network.

50. The mobile apparatus according to claim 43, wherein said sender sends the first list in one of a “Location Update Request” message, a “Routing Area Update Request” message, a “Connection Request” message or a “Channel Request” message.

51. The mobile apparatus according to claim 43, wherein said receiver receives the second list in one of a “Routing Area Update Reject” message, a “Routing Area Update Accept” message, a “Location Update Reject”, a “Location Update Accept” message, an “Authentication Request” message, a “Connection Setup” message, an “Immediate Assignment” message, a “Connection Release” message, a “Channel Release” message, a “Connection Reject” message or an “Immediate Assignment Reject” message.

52. A network apparatus for supporting a selection of at least one wireless network, the network apparatus comprising:
a receiver for receiving a first list containing information of at least a part of available wireless networks for a mobile apparatus;
an elector for electing at least one elected wireless network from the first list; and
a transmitter for transmitting a second list containing the at least one elected wireless network.

53. The network apparatus according to claim 52, wherein the second list contains at least two elected wireless networks.

54. The network apparatus according to claim 52, further comprising a priority block prioritizing wireless networks in the second list before sending the second list.

55. The network apparatus according to claim 52, further comprising a decoder for decrypting the first list.

56. The network apparatus according to claim 52, further comprising an encoder encrypting the second list before the second list is transmitted.

57. The network apparatus according to claim 52, wherein said receiver receives the first list in one of a “Location Update Request” message, a “Routing Area Update Request” message, a “Connection Request” message, a “Channel Request” message, an “Update Location Request” message or a “Send Authentication Info Request” message.

58. The network apparatus according to claim 52, wherein the second list is transmitted in one of a “Update Location response” message, an “Insert Subscriber Data request” message, a “Connection Setup” message, an “Immediate Assignment” message, a “Connection Release” message, a “Channel Release” message, a “Connection Reject” message or an “Immediate Assignment Reject” message.

59. The network apparatus according to claim 52, wherein the network apparatus is disposed in a home network of the mobile apparatus.

60. The network apparatus according to claim 52, wherein the network apparatus is a smart roaming server or contains a functionality of the smart roaming server.

61. A system for selecting at least one wireless network, the system comprising:
at least one mobile apparatus for selecting the at least one wireless network via the mobile apparatus, said mobile apparatus containing:
a detector for detecting available wireless networks available at said mobile apparatus;
a sender for sending a first list containing information of at least a part of the available wireless networks;
a receiver for receiving a second list containing at least one elected wireless network; and
a selector for selecting the wireless network taking the second list into account; and
at least one network apparatus for supporting a selection of the at least one wireless network, said network apparatus containing:
a network receiver for receiving the first list containing the information of at least the part of the available wireless networks for said mobile apparatus;
an elector for electing at least one wireless network from the first list; and
a transmitter for transmitting a second list containing at least one elected wireless network.

62. A non-transitory memory containing a computer program, comprising:
code for detecting available wireless networks available at a mobile apparatus;
code for sending a first list containing information of at least a part of the available wireless networks;
code for receiving a second list of elected wireless networks, wherein the second list containing at least one elected wireless network; and
code for selecting the least one wireless network taking the second list into account.

63. A non-transitory memory containing a computer program, comprising:
code for receiving a first list containing information of at least a part of available wireless networks at a mobile apparatus;
code for electing at least one wireless networks from the first list of the available wireless networks; and
code for transmitting a second list containing at least one elected wireless network.

64. The computer program according to claim 62, wherein the computer program is a computer program product bearing computer program code embodied therein for use with a computer.
